(19) United States
(12) Patent Application Publication
(10) Pub. No.: US 2026/0212812 A1
(43) Pub. Date: Jul. 23, 2026

(54) ELECTRONIC DEVICE FOR DRIVING PIXEL, AND CONTROL METHOD THEREFOR

(71) Applicant: SAMSUNG ELECTRONICS CO., LTD., Suwon-si (KR)

(72) Inventors: Wonkeun PARK, Suwon-si (KR); Youngki JUNG, Suwon-si (KR); Donghwan KIM, Suwon-si (KR); Donggun OH, Suwon-si (KR)

(73) Assignee: SAMSUNG ELECTRONICS CO., LTD., Suwon-si (KR)

(21) Appl. No.: 19/568,176

(22) Filed: Mar. 16, 2026

Related U.S. Application Data
(63) Continuation of application No. PCT/KR2024/014415, filed on Sep. 24, 2024.

(30) Foreign Application Priority Data
Oct. 10, 2023 (KR) 10-2023-0134276

(51) Int. Cl. G09G 3/32

(52) U.S. Cl. CPC G09G 3/32; G09G 2300/0852

(57) ABSTRACT

An electronic apparatus including a driving unit, an inorganic light-emitting element; and pixel circuitry, the pixel circuitry including: first circuitry including a switching transistor, the first circuitry providing a first current based on a first control voltage among the plurality of signals to the inorganic light-emitting element through the switching transistor; and second circuitry including a charging element connected to a gate of the switching transistor, the second circuitry charging the charging element with a second current based on a second control voltage among the plurality of signals, and cutting off a supply of the first current to the inorganic light-emitting element at a timing the switching transistor is blocked based on a voltage of the charging element reaching a predetermined voltage level such that the timing corresponds to the charging element being charged and no first current is supplied to the inorganic light-emitting element.

### CROSS REFERENCE TO RELATED APPLICATIONS

This application is a continuation application, filed under 35 U.S.C. §1 t 1(a), of International Application PCT/KR2024/014415, filed September 24, 2024, and is based on and claims priority under 35 U.S.C. §119 to Korean Patent Application No. 10-2023-0134276, filed on October 10, 2023 in the Korean Intellectual Property Office, the disclosures of which are incorporated by reference herein in their entireties.

### Technical Field

This disclosure relates to an electronic apparatus and a control method thereof, and particularly, to an electronic apparatus for driving a pixel and a control method thereof.

### Background Art

With an advancement in electronic technologies, various types of electronic apparatuses have been developed. In particular, display devices using a micro LED have been recently developed.

Most micro LED display models adopt a pulse width modulation (PWM) internal compensation driving method in which a driving current peak is fixed and a pulse width is adjusted. This is because in the case where a pulse amplitude modulation (PAM) driving method is used, a current peak may vary depending on gray, thereby causing a color shift phenomenon stemming from the attributes of micro LEDs.

In a conventional PWM internal compensation driving method, part of gate in panel (GIP) waveforms use a triangle wave, and accordingly, various types of image quality problems may be caused.

### Disclosure of Invention

### Solution to Problem

According to one embodiment, an electronic apparatus includes a driving unit, an inorganic light-emitting element, and pixel circuitry controlling the inorganic light-emitting element based on a plurality of signals output from the driving unit, the pixel circuitry including first circuitry that includes a switching transistor, and provides a first current based on a first control voltage among the plurality of signals to the inorganic light-emitting element through the switching transistor, and second circuitry that includes a charging element connected to a gate of the switching transistor, charges the charging element with a second current based on a second control voltage among the plurality of signals, and cuts off a supply of the first current to the inorganic light-emitting element as the switching transistor is blocked based on a voltage of the charging element reaching a predetermined voltage.

Additionally, the first circuitry may further include a first driving transistor, supply, based on a reset signal among the plurality of signals, a first initial voltage among the plurality of signals to a gate of the first driving transistor, and supply, based on a data setting signal among the plurality of signals, the first control voltage to a gate of the first driving transistor, while the second circuitry may further include a second driving transistor, supply, based on the reset signal, the first initial voltage to a gate of the second driving transistor, and supply, based on the data setting signal, the second control voltage to a gate of the second driving transistor.

Additionally, the first circuitry may supply, based on a light-emitting signal, a first driving voltage among the plurality of signals to a source of the first driving transistor, and provide the first current based on a gate-source voltage of the first driving transistor to the inorganic light-emitting element through the switching transistor, while the second circuitry may supply, based on the light-emitting signal, a second driving voltage among the plurality of signals to a source of the second driving transistor, and charge the charging element with the second current based on a gate-source voltage of the second driving transistor.

Further, the inorganic light-emitting element may emit light of luminance corresponding to magnitude of the first current, and a turn-on time of the switching transistor may be determined based on magnitude of the second current.

Additionally, the first current may be decreased as the first control voltage is increased, and increased as the first control voltage is decreased, and the second current may be decreased as the second control voltage is increased, and increased as the second control voltage is decreased.

Further, the second circuitry may supply a second initial voltage to the charging element based on the reset signal, and the second initial voltage may be a voltage that allows the switching transistor to be turned on.

Additionally, one end of the inorganic light-emitting element may be grounded, while the other end may be connected to the switching transistor, and the first initial voltage may be supplied to the other end based on the reset signal.

Further, the first circuit may further include a first capacitor connected to a gate of the first driving transistor, and a voltage of the gate of the first driving transistor may be maintained through the first capacitor, and the second circuitry may further include a second capacitor connected to a gate of the second driving transistor, and a voltage of the gate of the second driving transistor may be maintained through the second capacitor.

Additionally, the charging element may include a third capacitor, and capacitance of the third capacitor may be greater than capacitance of each of the first capacitor and the second capacitor.

Further, a W/L ratio of the first driving transistor may be greater than a W/L ratio of the second driving transistor.

Additionally, each of the plurality of signals may be a square signal or a DC signal.

Meanwhile, according to one embodiment, a control method of an electronic apparatus may include providing a first current based on a first control voltage among a plurality of signals output from a driving unit of the electronic apparatus to an inorganic light- emitting element of the electronic apparatus through a switching transistor, charging a charging element connected to a gate of the switching transistor with a second current based on a second control voltage among the plurality of signals, and cutting off a supply of the first current to the inorganic light-emitting element as the switching transistor is blocked based on a voltage of the charging element reaching a predetermined voltage.

Additionally, the method may further include supplying, based on a reset signal among the plurality of signals, a first initial voltage among the plurality of signals to a gate of a first driving transistor included in first circuitry and a gate of a second driving transistor included in second circuitry, and supplying, based on a data setting signal among the plurality of signals, the first control voltage to a gate of the first driving transistor and the second control voltage to a gate of the second driving transistor.

Additionally, the charging may include supplying, based on a light-emitting signal, a first driving voltage among the plurality of signals to a source of the first driving transistor and a second driving voltage among the plurality of signals to a source of the second driving transistor, providing the first current based on a gate-source voltage of the first driving transistor to the inorganic light-emitting element through the switching transistor, and charging the charging element with the second current based on a gate-source voltage of the second driving transistor.

Further, the inorganic light-emitting element may emit light of luminance corresponding to magnitude of the first current, and a turn-on time of the switching transistor may be determined based on magnitude of the second current.

Additionally, the first current may be decreased as the first control voltage is increased, and increased as the first control voltage is decreased, and the second current may be decreased as the second control voltage is increased, and increased as the second control voltage is decreased.

Further, the supplying a first initial voltage may include supplying a second initial voltage to the charging element based on the reset signal, and the second initial voltage may be a voltage that allows the switching transistor to be turned on.

Additionally, one end of the inorganic light-emitting element may be grounded, while the other end may be connected to the switching transistor, and the first initial voltage may be supplied to the other end based on the reset signal.

Further, a voltage of the gate of the first driving transistor may be maintained through a first capacitor connected to the gate of the first driving transistor, and a voltage of the gate of the second driving transistor may be maintained through a second capacitor connected to the gate of the second driving transistor.

Additionally, the charging element may include a third capacitor, and capacitance of the third capacitor may be greater than capacitance of each of the first capacitor and the second capacitor.

Further, a W/L ratio of the first driving transistor may be greater than a W/L ratio of the second driving transistor.

Additionally, each of the plurality of signals may be a square signal or a DC signal.

According to one embodiment, an electronic apparatus may include a driving unit, an inorganic light-emitting element; and pixel circuitry, the pixel circuitry may include: first circuitry including a switching transistor, the first circuitry providing a first current based on a first control voltage among the plurality of signals to the inorganic light-emitting element through the switching transistor; and second circuitry including a charging element connected to a gate of the switching transistor, the second circuitry charging the charging element with a second current based on a second control voltage among the plurality of signals, and cutting off a supply of the first current to the inorganic light-emitting element at a timing the switching transistor is blocked based on a voltage of the charging element reaching a predetermined voltage level such that the timing corresponds to the charging element being charged and no first current is supplied to the inorganic light-emitting element.

According to one embodiment, a method for controlling an electronic apparatus may include :providing a first current based on a first control voltage among a plurality of signals output from a driving unit of the electronic apparatus to an inorganic light-emitting element of the electronic apparatus through a switching transistor, charging a charging element connected to a gate of the switching transistor with a second current based on a second control voltage among the plurality of signals; and cutting off a supply of the first current to the inorganic light-emitting element at a timing the switching transistor is blocked based on a voltage of the charging element reaching a predetermined voltage level such that the timing corresponds to the charging element being charged and no first current is supplied to the inorganic light-emitting element.

### Brief Description of Drawings

FIGS. lA-1C are views provided to explain operations of pixel circuitry for an understanding of the subject matter of the disclosure;

FIG. 2 is a block diagram illustrating a configuration of an electronic apparatus according to one embodiment;

FIG. 3 is a view illustrating a circuitry configuration of an electronic apparatus according to one embodiment;

FIGS. 4-7 are views sequentially illustrating operations of an electronic apparatus according to one embodiment;

FIG. 8 is a view provided to explain a waveform of node 3 Node 3 based on gradation according to one embodiment; and

FIG. 9 is a flowchart provided to explain a control method of an electronic apparatus according to one embodiment.

### Mode for Invention

The objective of the disclosure is to provide an electronic apparatus for driving pixel circuitry without using a triangle wave, and a control method thereof.

Hereafter, the subject matter of the disclosure is described in detail with reference to the accompanying drawings.

General terms currently used as widely as possible are selected as the terms used in the embodiments of the disclosure considering functions in the disclosure, but may be changed based on the intention of those skilled in the art or a judicial precedent, the emergence of a new technology, or the like. Additionally, in a specific case, terms arbitrarily chosen by the applicant may be included in the terms used herein. In this case, the meanings of such terms are described in detail in the descriptions thereof in the disclosure. Accordingly, the terms used in the disclosure need to be defined based on the meanings thereof and particulars throughout the disclosure rather than simply names thereof.

In the disclosure, the expression "have", "may have", "include", "may include" or the like, indicates the existence of a corresponding feature (e.g., a numerical value, a function, an operation or an element such as a part), and does not exclude the existence of an additional feature.

The expression at least one of A or/and B is to be understood as indicating any one of "A" or "B" or "A and B".

The expression "1st", "2nd", "first", "second", or the like, used in the disclosure, may be used to refer to various elements regardless of their order and/or importance, and may be used merely to differentiate one element from another but not intended to limit the elements.

In the disclosure, singular forms include plural forms as well, unless explicitly indicated otherwise. In the disclosure, the term "include" or "comprised of' and the like specify the presence of stated features, numbers, steps, operations, elements, components or combinations thereof but do not imply the exclusion of the presence or addition of one or more other features, numbers, steps, operations, elements, parts or combinations thereof.

In the disclosure, the term user may refer to a person who uses an electronic apparatus or an apparatus (e.g., an artificial intelligence electronic apparatus) which uses an electronic apparatus.

Hereafter, various embodiments of the disclosure are described in greater detail with reference to the accompanying drawings.

FIGS. 1A-1C are views provided to explain operations of pixel circuitry for an understanding of the subject matter of the disclosure.

FIG. 1A illustrates one example of pixel circuitry for an understanding of the subject matter of the disclosure. In the pixel circuitry of FIG. 1A, an EmiPWM(n) signal and an EmiPAM(n) signal may turn on a transistor to which each signal is provided. A Sweep(n) signal may adjust a pulse width with respect to each gradation, and may be a triangle wave.

FIG. 1B illustrates one example of an Emi_PWM(n) signal, an Emi PAM(n) signal and a Sweep(n) signal for an understanding of the subject matter of the disclosure. Referring to FIG. 1B, the Emi_PWM(n) signal and the Emi PAM(n) signal may be square waves, and the Sweep(n) signal may be a triangle wave.

FIG. 1C is a view provided to explain the features of the square waves and the triangle wave for an understanding of the subject matter of the disclosure. As illustrated in FIG. 1C, compared to the square wave, the triangle wave may cause a rising time and a falling time of a waveform with a large width with respect to output capacity fluctuation (e.g., RC delay, coupling, TFT characteristic fluctuation and the like) of GIP. A deviation of such a GIP output may have a direct effect on screen quality, and in particular, the triangle wave may have a greater effect on the screen quality than the square wave.

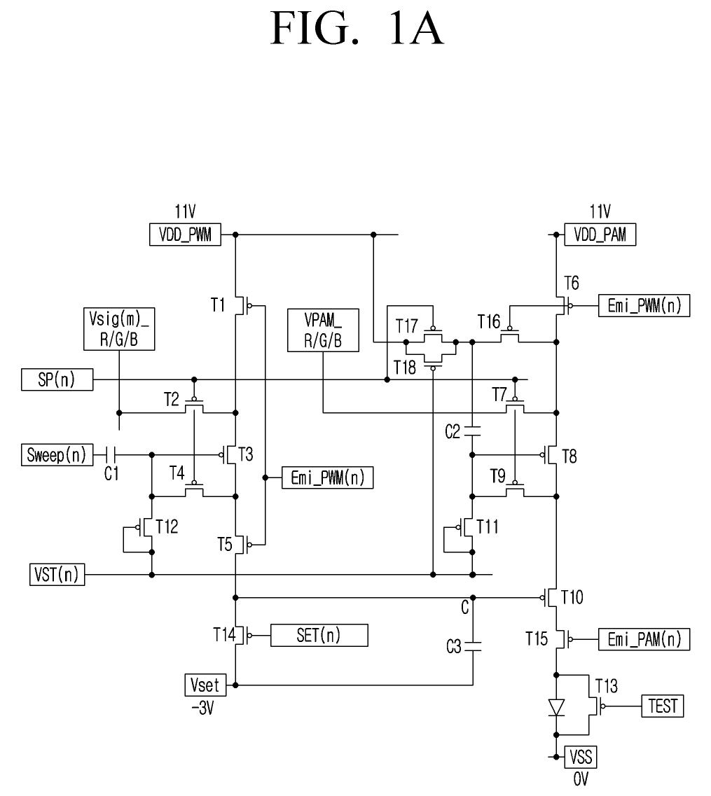

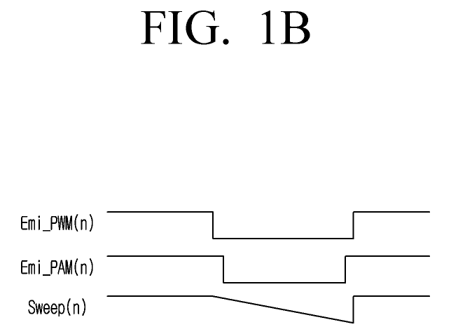

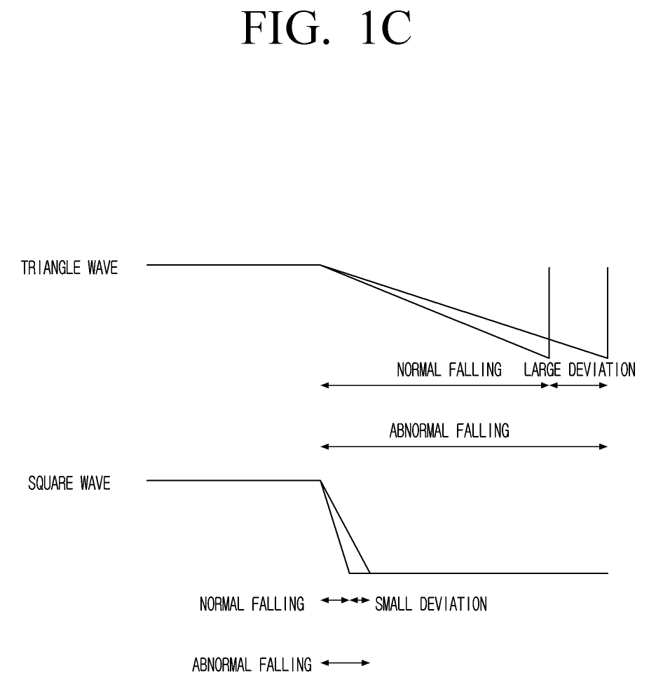

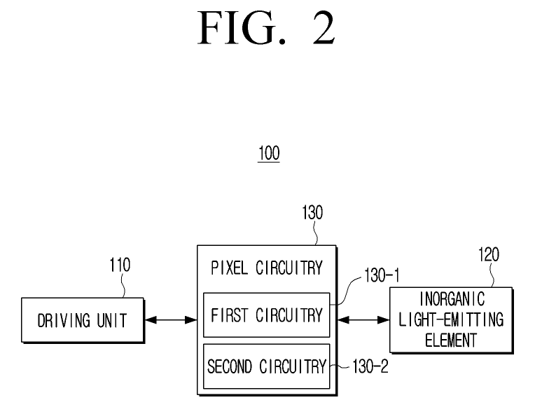

FIG. 2 is a block diagram illustrating a configuration of an electronic apparatus 100 according to one embodiment.

The electronic apparatus 100 may include a driving unit 110, an inorganic light- emitting element 120 and pixel circuitry 130. However, the electronic apparatus 100 is not limited thereto, and may also include a driving unit, a plurality of inorganic light-emitting elements and a plurality of pixel circuitries. Alternatively, the electronic apparatus 100 may also include a plurality of driving units, a plurality of inorganic light-emitting elements and a plurality of pixel circuitries. In other words, the electronic apparatus 100 may also include a plurality of inorganic light-emitting elements which is disposed in a matrix form and is operated respectively as a sub pixel, a plurality of pixel circuitries which controls the plurality of inorganic light-emitting elements respectively, and a plurality of driving units which controls the plurality of pixel circuitries. Herein, each of the plurality of driving units may also control two or more pixel circuitries. However, hereafter, one pixel circuitry 130 controlling one inorganic light-emitting element 120, and one driving unit 110 controlling one pixel circuitry 130 are described for convenience of description.

The driving unit 110 may drive the pixel circuitry 130. For example, the driving unit 110 may provide various types of control signals, data signals, power signals and the like to the pixel circuitry 130 to drive the pixel circuitry 130.

The driving unit 110 may include at least one gate driver circuitry (or scan driver circuitry) providing a control signal for driving the plurality of inorganic light-emitting elements disposed in a matrix form based on a row-line unit.

The driving unit 110 may include source driver circuitry (or data driver circuitry) for providing a second control voltage (e.g., PWM Data) described hereafter to the plurality of inorganic light-emitting elements (e.g., sub pixels) disposed in a matrix form.

The driving unit 110 may also include MUX circuitry for selecting a plurality of sub pixels constituting a pixel.

The driving unit 110 may include driving voltage provision circuitry for providing a plurality of signals described hereafter to the inorganic light-emitting element.

The driving unit 110 may include clock signal provision circuitry providing various types of clock signals for driving gate driver circuitry or data driver circuitry.

The inorganic light-emitting element 120 may be electrically connected with the pixel circuitry 130, and may emit light based on a current provided from the pixel circuitry 130. The inorganic light-emitting element 120 may be mounted on the pixel circuitry 130.

The inorganic light-emitting element 120 may be a sub pixel of the electronic apparatus 100, and the type of the inorganic light-emitting element may be determined based on a color of emitted light. For example, the inorganic light-emitting element 120 may be a red R inorganic light-emitting element emitting red light, a green G inorganic light-emitting element emitting green light, and a blue B inorganic light-emitting element emitting blue light. However, the inorganic light-emitting element may not be limited thereto, and may be a white w inorganic light-emitting element emitting white light, and may emit light in various colors. In the case where the inorganic light-emitting element 120 is a white w inorganic light-emitting element, the electronic apparatus 100 may further include an optical conversion layer for converting white light of the inorganic light-emitting element 120 into light of a different wavelength, a filter and the like.

The inorganic light-emitting element 120 may be a light-emitting element using an inorganic material. For example, the inorganic light-emitting element 120 may be a micro light-emitting diode (a micro LED or μLED) having a size of less than or equal to 100 μm. However, the inorganic light-emitting element is not limited thereto, and an organic light- emitting element (an organic light-emitting diode (OLED)) using an organic material may be used instead of the inorganic light-emitting element 120.

The inorganic light-emitting element 120 may express a gradation value of different brightness based on magnitude or a pulse width of a current provided from the pixel circuitry 130. Herein, the pulse width of a current may be referred to as a duty ratio of a current or a driving duration of a current.

For example, the inorganic light-emitting element 120 may express a brighter gradation value as the magnitude of a current is increased. Additionally, the inorganic light- emitting element 120 may express a brighter gradation value as the pulse width of a current is increased (in other words, the duty ratio of a current is increased or the driving duration of a current is increased).

The pixel circuitry 130 may control the inorganic light-emitting element 120 based on a plurality of signals output from the driving unit 110. Herein, each of the plurality of signals may be a square-wave signal or a DC signal.

The pixel circuitry 130 may include first circuitry 130-1 for controlling brightness of the inorganic light-emitting element 120, and second circuitry 130-2 for controlling a light-emitting time of the inorganic light-emitting element 120.

For example, the first circuitry 130-1 may include a switching transistor, and provide a first current based on a first control voltage among the plurality of signals to the inorganic light-emitting element 120 through the switching transistor. In other words, the first circuitry 130-1 may control the brightness of the inorganic light-emitting element based on the first control voltage. The second circuitry 130-2 may include a charging element connected to a gate of the switching transistor, and charge the charging element with a second current based on a second control voltage among the plurality of signals, and as the voltage of the charging element reaches a predetermined voltage, the switching transistor may be blocked and the supply of the first current to the inorganic light-emitting element 120 may be cut off. In other words, the second circuitry 130-2 may control the light-emitting time of the inorganic light- emitting element 120 based on the second control voltage.

The first circuitry 130-1 may further include a first driving transistor, and supply a first initial voltage among the plurality of signals to a gate of the first driving transistor based on a reset signal among the plurality of signals, and supply a first control voltage to the gate of the first driving transistor based on a data setting signal among the plurality of signals. The second circuitry 130-2 may further include a second driving transistor, and supply a first initial voltage to a gate of the second driving transistor based on a reset signal, and supply a second control voltage to the gate of the second driving transistor based on a data setting signal. In other words, the first initial voltage may be supplied to the gate of the first driving transistor, and then the first control voltage may be supplied to the gate of the first driving transistor, while the first initial voltage may be supplied to the gate of the second driving transistor, and then the second control voltage may be supplied to the gate of the second driving transistor.

The first circuitry 130-1 may supply a first driving voltage among the plurality of signals based on a light-emitting signal to a source of the first driving transistor, and provide a first current based on a gate-source voltage of the first driving transistor to the inorganic light- emitting element 120 through the switching transistor. The second circuitry 130-2 may supply a second driving voltage among the plurality of signals based on a light-emitting signal to a source of the second driving transistor, and charge the charging element with a second current based on a gate-source voltage of the second driving transistor. Accordingly, the inorganic light-emitting element 120 may emit light of luminance corresponding to magnitude of the first current, and a turn-on time of the switching transistor may be determined based on magnitude of the second current.

The first driving voltage may have a predetermined first voltage value, while the second driving voltage may have a predetermined second voltage value. In other words, the gate-source voltage of the first driving transistor may be changed by the first control voltage, and the gate-source voltage of the second driving transistor may be changed by the second control voltage. Accordingly, the first current may be decreased as the first control voltage is increased, and increased as the first control voltage is decreased, while the second current may be decreased as the second control voltage is increased, and increased as the second control voltage is decreased.

The second circuitry 130-2 may supply a second initial voltage to the charging element based on a reset signal, and the second initial voltage may be a voltage that allows the switching transistor to be turned on. One end of the inorganic light-emitting element 120 may be grounded, and the other end may be connected to the switching transistor, and based on a reset signal, supplied with the first initial voltage. In other words, the switching transistor may be turned on after a staged signal flow according to a reset signal, and the first current provided from the first circuitry 130-1 may be provided as it is to the inorganic light-emitting element 120.

The first circuitry 130-1 may further include a first capacitor connected to the gate of the first driving transistor, and the voltage of the gate of the first driving transistor may be maintained through the first capacitor, and the second circuitry 130-2 may further include a second capacitor connected to the gate of the second driving transistor, and the voltage of the gate of the second driving transistor may be maintained through the second capacitor.

The charging element may include a third capacitor, and capacitance of the third capacitor may be greater than that of each of the first capacitor and the second capacitor.

A W/L ratio of the first driving transistor may be greater than that of the second driving transistor.

A specific circuitry configuration and an operation of the pixel circuitry 130 are described with reference to the following drawings.

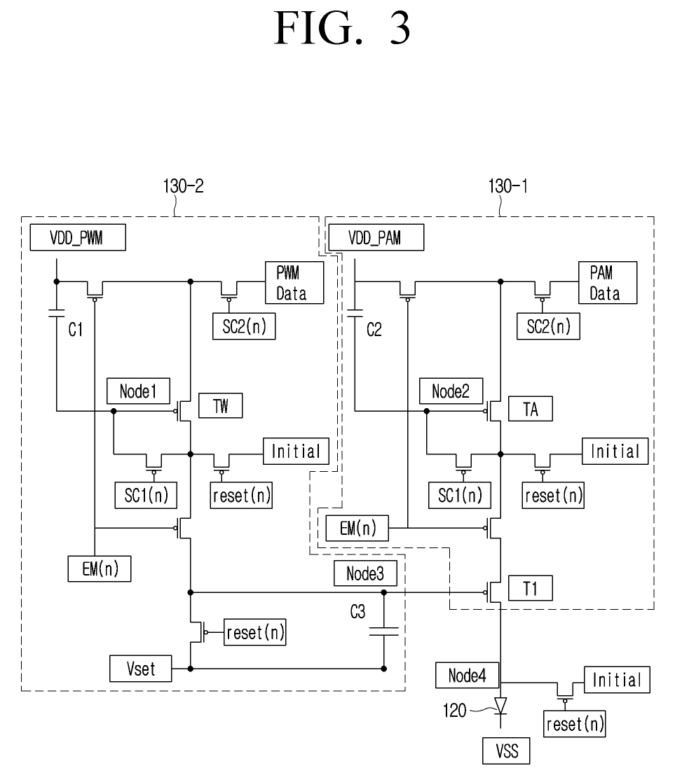

Hereafter, a circuitry configuration and operations of the electronic apparatus 100 are described in greater detail with reference to FIGS. 3-8. In FIGS. 3-8, an individual embodiment is described for convenience of description. However, the individual embodiment of FIGS. 3-8 may also be implemented in a combined state.

FIG. 3 is a view illustrating a circuitry configuration of an electronic apparatus 100 according to one embodiment.

In FIG. 3, the inorganic light-emitting element 120, the first circuitry 130-1 and the second circuitry 130-2 excluding the driving unit 110 are illustrated for convenience of description. Additionally, the portion represented by (n) among the plurality of signals in FIG. 3 means a sub pixel included in an n^{th} row line.

The first circuitry 130-1 may include a first driving transistor TA, a switching transistor T1 of which a drain is connected to the inorganic light-emitting element 120 while a gate is connected to the second circuitry, a 1-1 transistor that is connected to a drain and a gate of the first driving transistor TA and performs a switching operation based on an SC1(n) signal, a 1-2 transistor that is connected to the drain of the first driving transistor TA and performs a switching operation based on a reset signal reset(n), a 1-3 transistor that is connected to a source of the first driving transistor TA and performs a switching operation based on a data setting signal SC2(n), a first capacitor C2 of which one end is connected to the gate of the first driving transistor TA, a 1-4 transistor that is connected to the source of the first driving transistor TA and the other end of the first capacitor C2 and performs a switching operation based on a light- emitting signal EM(n), and a 1-5 transistor that is connected to the drain of the first driving transistor TA and a source of the switching transistor T1 and performs a switching operation based on a light-emitting signal EM(n).

The 1-2 transistor may supply a first initial voltage Initial to the drain of the first driving transistor TA based on the reset signal reset(n). The 1-3 transistor may supply a first control voltage PAM Data to the source of the first driving transistor TA based on the data setting signal SC2(n). The 1-4 transistor may supply a first driving voltage VDD_PAM to the source of the first driving transistor TA based on the light-emitting signal EM(n). The 1-5 transistor may provide a first current flowing in the first driving transistor TA to the inorganic light-emitting element 120 through the switching transistor T1 based on the light-emitting signal EM(n).

The second circuitry 130-2 may include a second driving transistor TW, a 2-1 transistor that is connected to a drain and a gate of the second driving transistor TW and performs a switching operation based on an SC1(n) signal, a 2-2 transistor that is connected to the drain of the second driving transistor TW and performs a switching operation based on a reset signal reset(n), a 2-3 transistor that is connected to a source of the second driving transistor TW and performs a switching operation based on a data setting signal SC2(n), a second capacitor C1 of which one end is connected the gate of the second driving transistor TW, a 2- 4 transistor that is connected to the source of the second driving transistor TW and the other end of the second capacitor C1 and performs a switching operation based on a light-emitting signal EM(n), a 2-5 transistor that is connected to the drain of the second driving transistor TW and a gate of a switching transistor T1 and performs a switching operation based on a light- emitting signal EM(n), a 2-6 transistor that is connected to a drain of the 2-5 transistor and the gate of the switching transistor T1 and performs a switching operation based on a reset signal reset(n), and a third capacitor C3 of which one end is connected to the drain of the 2-5 transistor and the gate of the switching transistor T1 while the other end is connected to a drain of the 2- 6 transistor. Herein, the third capacitor C3 may be operated as a charging element.

The 2-2 transistor may supply a first initial voltage Initial to the drain of the second driving transistor TW based on the reset signal reset(n). The 2-3 transistor may supply a second control voltage PWM Data to the source of the second driving transistor TW based on the data setting signal SC2(n). The 2-4 transistor may supply a second driving voltage VDD PWM to the source of the second driving transistor TW based on the light-emitting signal EM(n). The 2-5 transistor may provide a second current flowing in the second driving transistor TW to the third capacitor C3 based on the light-emitting signal EM(n). The 2-6 transistor may supply a second initial voltage Vset to both ends of the third capacitor C3 based on the reset signal reset(n).

The electronic apparatus 100 may further include circuitry for initializing a node to which the inorganic light-emitting element 120 and the switching transistor T I are connected. For example, the electronic apparatus 100 may further include a third transistor that is connected to the node to which the inorganic light-emitting element 120 and the switching transistor T1 are connected, and performs a switching operation based on a reset signal reset(n). The third transistor may supply a first initial voltage Initial to the node to which the inorganic light-emitting element 120 and the switching transistor T1 are connected, based on the reset signal reset(n).

Capacitance of the third capacitor C3 may be greater than that of each of the first capacitor C2 and the second capacitor C1.

A W/L ratio of the first driving transistor T 1 may be greater than that of the second driving transistor.

The electronic apparatus 100 may further include a fourth transistor that performs a switching operation based on a light-emitting signal EM(n), at an anode terminal of the first driving transistor T1.

Operations of the pixel circuitry 130 are described with reference to FIGS. 4-7.

FIGS. 4-7 are views sequentially illustrating operations of an electronic apparatus 100 according to one embodiment.

As shown at the upper end of FIG. 4, the light-emitting signal EM(n), the SC 1(n) signal, the reset signal reset(n), and the data setting signal SC2(n) may all be high values in a 410-1 section, and all the transistors may be in a turn-off state in the pixel circuitry 130 illustrated at the lower end of FIG. 4. This may also be applied to a 410-2 section that is the following section.

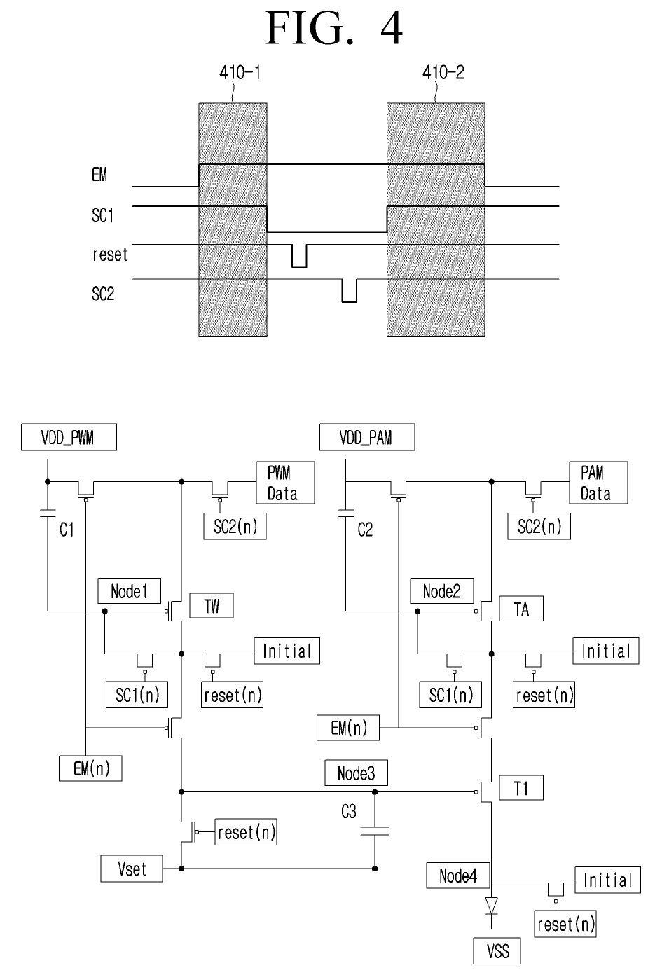

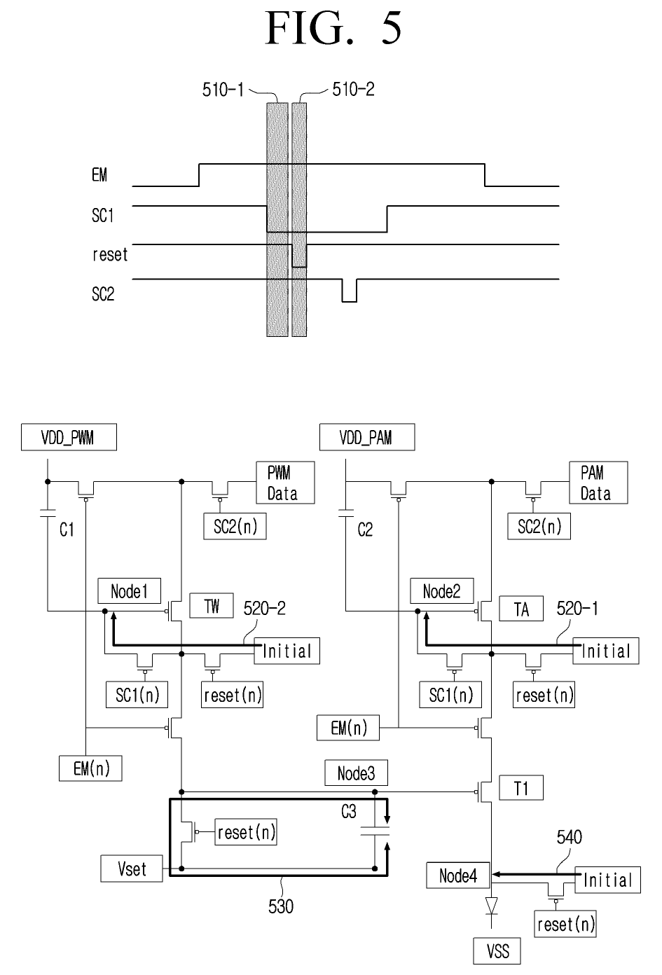

In a 510-1 section at the upper end of the FIG. 5, the SC 1(n) signal may be changed from a high value to a low value, and accordingly, the 1-1 transistor and the 2-1 transistor may be turned on.

In a 510-2 section at the upper end of FIG. 5, the reset signal reset(n) may be changed from a high value to a low value, and accordingly, the 1-2 transistor, the 2-2 transistor, the 2-6 transistor and the third transistor may be turned on.

As illustrated at the lower end of FIG. 5, as the 1-2 transistor is turned on, the first initial voltage Initial may be supplied to node 2 Node 2 through the 1-2 transistor and the 1-1 transistor (520-1), and may be maintained by the first capacitor C2. Additionally, as the 2- 2 transistor is turned on, the first initial voltage Initial may be supplied to node 1 Node 1 through the 2-2 transistor and the 2-1 transistor (520-2), and may be maintained by the second capacitor C1. Further, as the 2-6 transistor is turned on, the second initial voltage Vset may be supplied to both ends of the third capacitor C3 through the 2-6 transistor (530). Furthermore, as the third transistor is turned on, the first initial voltage Initial may be supplied through the third transistor to node 4 Node 4 to which the inorganic light-emitting element 120 and the switching transistor T1 are connected (540). Herein, the switching transistor T1 may be turned on based on the second initial voltage Vset.

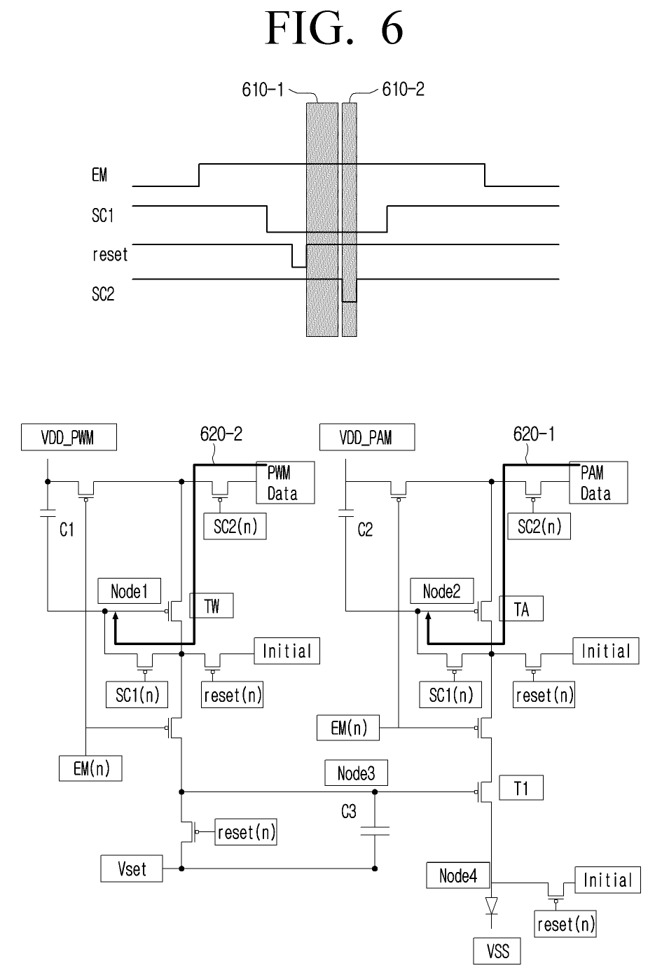

In a 610-1 section at the upper end of the FIG. 6, the reset signal reset(n) may be changed from a low value to a high value, and the 1 -2 transistor, the 2-2 transistor, the 2-6 transistor and the third transistor may be turned off.

In a 610-2 section at the upper end of FIG. 6, the data setting signal SC2(n) maybe changed from a high value to a low value, and accordingly, the 1-3 transistor and the 2- 3 transistor may be turned on.

As illustrated at the lower end of FIG. 6, as the 1-3 transistor is turned on, the first control voltage PAM Data may be supplied to node 2 Node 2 through the first driving transistor TA and the 1-1 transistor (620-1), and may be maintained by the first capacitor C2. Additionally, as the 2-3 transistor is turned on, the second control voltage PWM Data may be supplied to node 1 Node 1 through the second driving transistor TW and the 2-1 transistor (620- 2), and may be maintained by the second capacitor C1.

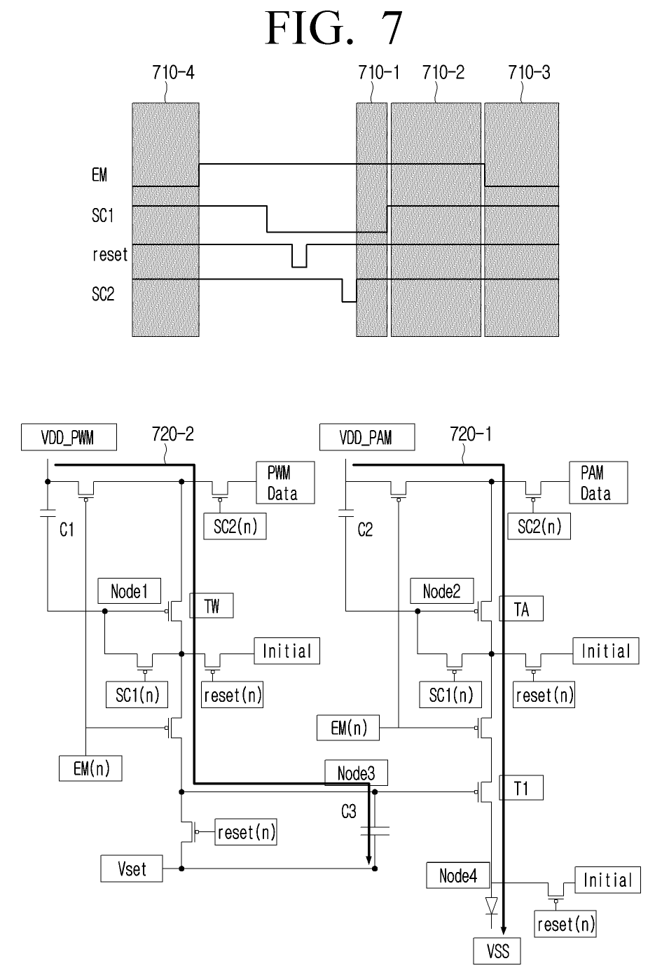

Ina 710-1 section at the upper end of FIG. 7, the data setting signal SC2(n) may be changed from a low value to a high value, and accordingly, the 1-3 transistor and the 2-3 transistor may be turned off.

In a 710-2 section at the upper end of FIG. 7, the SC 1(n) signal may be changed from a low value to a high value, and accordingly, the 1-1 transistor and the 2-1 transistor may be turned off.

In a 710-3 section at the upper end of FIG. 7, the light-emitting signal EM(n) may be changed from a high value to a low value, and accordingly, the 1-4 transistor, the 1-5 transistor, the 2-4 transistor, and the 2-5 transistor may be turned on.

As illustrated at the lower end of FIG. 7, as the 1-4 transistor and the 1-5 transistor are turned on, the first driving voltage VDD_PAM may be supplied to the source of the first driving transistor TA through the 1 -4 transistor, and the first current based on the gate- source voltage of the first driving transistor TA may be provided to the inorganic light-emitting element 120 through the 1-5 transistor and the switching transistor T1 transistor T1 (720-1). As the 2-4 transistor and the 2-5 transistor are turned on, the second driving voltage VDD_PWM may be supplied to the source of the second driving transistor TW through the 2-4 transistor, and the second current based on the gate-source voltage of the second driving transistor TW may be provided to the third capacitor C3 through the 2-5 transistor (720-2).

In other words, the inorganic light-emitting element 120 may emit light with brightness corresponding to the first current. Additionally, in the case where the switching transistor T1 is turned off as the voltage of the third capacitor C3 is gradually increased based on the second current, the first current may not be supplied to the inorganic light-emitting element 120, putting an end to the emission of light.

An operation in a 710-4 section at the upper end of FIG. 7 may be considered to be the same (a light-emitting state) as that in the 710-3 section at the upper end of FIG. 7, and in the case where the pixel circuitry 130 expresses a new pixel value, the operations of FIGS. 4-7 may be repeated.

In the above, the plurality of signals provided by the driving unit 110 may be square signals or DC signals. In other words, since the electronic apparatus 100 does not use triangular wave signals, the occurrence of the problems mentioned with reference to FIG. 1C may be prevented, and the sensitivity of the output capacity fluctuation of GIP may be reduced, providing an image of higher quality.

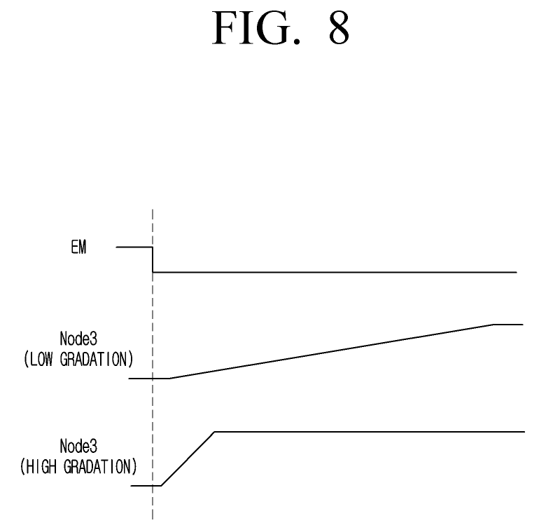

FIG. 8 is a view provided to explain a waveform of node 3 Node 3 based on gradation according to one embodiment.

As mentioned with reference to FIG. 7, in the case where the third capacitor C3 is charged with the second current, the voltage of the gate of the switching transistor T1 may be increased.

For example, in the case of expression of high gradation, the driving unit 110 may provide a second control signal PWM Data corresponding to the high gradation to the pixel circuitry 130, and in the case of expression of low gradation, may provide a second control signal PWM Data corresponding to the low gradation to the pixel circuitry 130. The drawing in the middle of FIG. 8 shows one example in the case where the second control signal PWM Data corresponding to the high gradation is supplied to the pixel circuitry 130, while the drawing at the lower end of FIG. 8 shows one example in the case where the second control signal PWM Data corresponding to the low gradation is supplied to the pixel circuitry 130, and the former requires a longer time taken to reach a high value than the latter, and enables an expression of relatively high gradation.

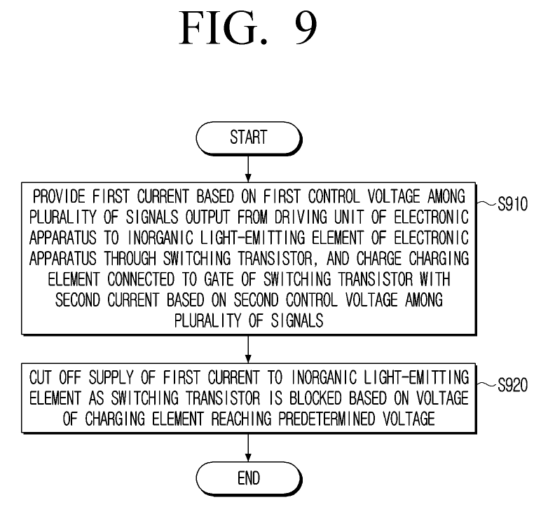

FIG. 9 is a flowchart provided to explain a control method of an electronic apparatus according to one embodiment.

A first current based on a first control voltage among a plurality of signals output from a driving unit of an electronic apparatus is provided to an inorganic light-emitting element of the electronic apparatus through a switching transistor, and a charging element connected to a gate of the switching transistor is charged with a second current based on a second control voltage among the plurality of signals (S910). Additionally, as a voltage of the charging element reaches a predetermined voltage, the switching transistor is blocked to cut off the supply of the first current to the inorganic light-emitting element (S920).

Additionally, the method may further include supplying, based on a reset signal among the plurality of signals, a first initial voltage among the plurality of signals to a gate of a first driving transistor included in first circuitry and to a gate of a second driving transistor included in second circuitry, and supplying, based on a data setting signal among the plurality of signals, a first control voltage to the gate of the first driving transistor and a second control voltage to the gate of the second driving transistor.

Additionally, the charging (S910) may include supplying a first driving voltage among the plurality of signals to a source of the first driving transistor, supplying a second driving voltage among the plurality of signals to a source of the second driving transistor, providing the first current based on a gate-source voltage of the first driving transistor to the inorganic light-emitting element through the switching transistor, based on a light-emitting signal, and charging the charging element with the second current based on a gate-source voltage of the second driving transistor.

Additionally, the inorganic light-emitting element may emit light of luminance corresponding to the magnitude of the first current, and a turn-on time of the switching transistor may be determined based on the magnitude of the second current.

Additionally, the first current may be decreased as the first control voltage is increased and increased as the first control voltage is decreased, while the second current may be decreased as the second control voltage is increased and increased as the second control voltage is decreased.

Additionally, the supplying a first initial voltage may include supplying a second initial voltage to the charging element based on the reset signal, and the second initial voltage may be a voltage that allows the switching transistor to be turned on.

Additionally, one end of the inorganic light-emitting element may be grounded, while the other is connected to the switching transistor, and based on the reset signal, the first initial voltage may be supplied to the other end.

Additionally, as for the gate of the first driving transistor, a voltage may be maintained through a first capacitor connected to the gate of the first driving transistor, and as for the gate of the second driving transistor, a voltage may be maintained through a second capacitor connected to the gate of the second driving transistor.

Additionally, the charging element may include a third capacitor, and capacitance of the third capacitor may be greater than that of each of the first capacitor and the second capacitor.

Further, a W/L ratio of the first driving transistor may be greater than that of the second driving transistor.

Furthermore, each of the plurality of signals may be a square signal or a DC signal.

According to the embodiments set forth herein, since the electronic apparatus does not use triangular wave signals, the sensitivity of the output capacity fluctuation of GIP may be decreased, providing an image of higher quality.

Meanwhile, the embodiments described above may be implemented with software including instructions stored in a storage medium readable by a machine (e.g., a computer). The machine, as a device capable of calling the stored instructions from the storage media and operating according to the called instructions, may include an electronic apparatus (e.g., electronic apparatus A) according to the disclosed embodiments. Based on the instructions being executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term "non-transitory" only means that the storage medium does not include a signal and that the storage medium is tangible, while the term does not differentiate semi-permanent or temporary storage of data in the storage medium.

According to the embodiments set forth herein, the method may be provided in a computer program product. The computer program product may be exchanged between a seller and a purchaser as a commodity. The computer program product may be distributed in the form of a machine-readable storage medium (e.g., compact disc read only memory (CD- ROM)) or distributed online through an application store (e.g., Play Store^{TM}). In the case of online distribution, at least part of the computer program product may be stored at least temporarily, or may be generated temporarily in a storage medium such as a manufacturer's server, a server of an application store, or memory of a relay server.

Additionally, the embodiments described above may be implemented in a recording medium readable by a computer or a device similar to a computer by using software, hardware or a combination thereof. In some cases, the embodiments set forth herein may be implemented as a processor itself. In the case of software implementation, the embodiments such as steps and functions described herein may be implemented with separate software modules. Each software may perform one or more functions and operations set forth herein.

Meanwhile, computer instructions for performing processing operations of the apparatus according to the embodiments described above may be stored in a non-transitory computer-readable medium. The computer instructions stored in the non-transitory computer- readable medium, when executed by a processor of a specific device, cause the apparatus to perform the processing operations in the apparatus according to the embodiments described above. The non-transitory computer-readable medium means a medium that stores data semi- permanently and is readable by a machine, rather than a medium such as a register, cache, and memory and the like that store data temporarily. Specific examples of the non-transitory computer-readable medium may include a CD, a DVD, a hard disc, a blue-ray disc, a USB, a memory card, and ROM and the like.

Further, each of the elements (e.g., a module or a program) according to the embodiments described above may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform functions performed by each corresponding element prior to the integration, in an identical way or a similar way. Operations performed by a module, a program, or another element, according to the embodiments, may be executed sequentially, in parallel, repetitively, or heuristically, or at least some of the operations may be executed in a different order, omitted, or include another operation.

While example embodiments of the disclosure are illustrated and described above, embodiments of the disclosure are not limited to specific embodiments set forth herein, and certainly, various modifications thereof may be made by those skilled in the art, without departing from the subject matter of the disclosure, claimed in the section of claims, and should not be understood as separating from the technical spirit or prospect of the disclosure.

1. An electronic apparatus comprising:
a driving unit configured to output a plurality of signals;
an inorganic light-emitting element; and
pixel circuitry configured to control the inorganic light-emitting element based on the plurality of signals from the driving unit,
the pixel circuitry comprising:
first circuitry including a switching transistor, the first circuitry providing a first current based on a first control voltage among the plurality of signals to the inorganic light- emitting element through the switching transistor; and
second circuitry including a charging element connected to a gate of the switching transistor, the second circuitry charging the charging element with a second current based on a second control voltage among the plurality of signals, and cutting off a supply of the first current to the inorganic light-emitting element at a timing the switching transistor is blocked based on a voltage of the charging element reaching a predetermined voltage level such that the timing corresponds to the charging element being charged and no first current is supplied to the inorganic light-emitting element.

2. The electronic apparatus of claim 1,
wherein the first circuitry further includes a first driving transistor, and the first circuitry supplies, based on a reset signal among the plurality of signals, a first initial voltage among the plurality of signals to a gate of the first driving transistor, and supplies, based on a data setting signal among the plurality of signals, the first control voltage to the gate of the first driving transistor, and
the second circuitry further includes a second driving transistor, and the second circuitry supplies, based on the reset signal, the first initial voltage to a gate of the second driving transistor, and supplies, based on the data setting signal, the second control voltage to the gate of the second driving transistor.

3. The electronic apparatus of claim 2,
wherein the first circuitry supplies, based on a light-emitting signal, a first driving voltage among the plurality of signals, to a source of the first driving transistor, and provides the first current based on a gate-source voltage of the first driving transistor to the inorganic light-emitting element through the switching transistor, and
the second circuitry supplies, based on the light-emitting signal, a second driving voltage among the plurality of signals to a source of the second driving transistor, and charges the charging element with the second current based on a gate-source voltage of the second driving transistor.

4. The electronic apparatus of claim 3,
wherein the inorganic light-emitting element emits light of luminance corresponding to a magnitude of the first current, and
a turn-on time of the switching transistor is determined based on a magnitude of the second current.

5. The electronic apparatus of claim 3,
wherein the first current decreases as the first control voltage increases, and the first current increases as the first control voltage decreases, and
the secondcurrent decreases as the secondcontrolvoltage increases,and the secondcurrent increasesas the second controlvoltage decreases.

6. The electronic apparatus of claim 2,
wherein the second circuitry supplies a second initial voltage to the charging element based on the reset signal, wherein the second initial voltage is at a voltage level that allows the switching transistor to be turned on.

7. The electronic apparatus of claim 2,
wherein an end of the inorganic light-emitting element is grounded while an other end is connected to the switching transistor, and
the first initial voltage is supplied to the other end based on the reset signal.

8. The electronic apparatus of claim 2,
wherein the first circuitry further includes a first capacitor connected to the gate of the first driving transistor, and a gate voltage of the first driving transistor is maintained through the first capacitor, and
the second circuitry further includes a second capacitor connected to the gate of the second driving transistor, and a gate voltage of the second driving transistor is maintained through the second capacitor.

9. The electronic apparatus of claim 8,
wherein the charging element includes a third capacitor, and
a capacitance of the third capacitor is greater than both a capacitance of the first capacitor and a capacitance of the second capacitor.

10. The electronic apparatus of claim 2,
wherein a W/L ratio of the first driving transistor is greater than a W/L ratio of the second driving transistor.

11. The electronic apparatus of claim 1,
wherein each of the plurality of signals is a square signal or a DC signal.

12. A method for controlling an electronic apparatus, the method comprising:
providing a first current based on a first control voltage among a plurality of signals output from a driving unit of the electronic apparatus to an inorganic light-emitting element of the electronic apparatus through a switching transistor,
charging a charging element connected to a gate of the switching transistor with a second current based on a second control voltage among the plurality of signals; and
cutting off a supply of the first current to the inorganic light-emitting element at a timing the switching transistor is blocked based on a voltage of the charging element reaching a predetermined voltage level such that the timing corresponds to the charging element being charged and no first current is supplied to the inorganic light-emitting element.

13. The method of claim 12 further comprising:
supplying, based on a reset signal among the plurality of signals, a first initial voltage among the plurality of signals to a gate of a first driving transistor included in first circuitry and a gate of a second driving transistor included in second circuitry; and
supplying, based on a data setting signal among the plurality of signals, the first control voltage to the gate of the first driving transistor and the second control voltage to the gate of the second driving transistor.

14. The method of claim 13,
the charging including:
supplying, based on a light-emitting signal, a first driving voltage among the plurality of signals to a source of the first driving transistor, and a second driving voltage among the plurality of signals to a source of the second driving transistor; and
providing the first current based on a gate-source voltage of the first driving transistor to the inorganic light-emitting element through the switching transistor, and charging the charging element with the second current based on a gate-source voltage of the second driving transistor.

15. The method of claim 14,
wherein the inorganic light-emitting element emits light of luminance corresponding to a magnitude of the first current, and
a turn-on time of the switching transistor is determined based on a magnitude of the second current.4
